(19) United States
(12) Patent Application Publication
(10) Pub. No.: US 2023/0104802 A1
(43) Pub. Date: Apr. 6, 2023

(54) CONTROL DEVICE, CONTROL METHOD AND STORAGE MEDIUM

(71) Applicant: NEC Corporation, Minato-ku, Tokyo (JP)

(72) Inventors: Hiroyuki OYAMA, Minato-ku, Tokyo (JP); Nobuharu KAMI, Minato-ku, Tokyo (JP); Massatsugu OGAWA, Minato-ku, Tokyo (JP); Hisaya WAKAYAMA, Minato-ku, Tokyo (JP); Mineto SATOH, Minato-ku, Tokyo (JP); Takehiro ITOU, Minato-ku, Tokyo (JP)

(73) Assignee: NEC Corporation, Minato-ku, Tokyo (JP)

(21) Appl. No.: 17/799,711

(22) PCT Filed: Feb. 25, 2020
(86) PCT No.: PCT/JP2020/007448

§ 371 Date: Aug. 15, 2022

(51) Int. Cl. B25J 9/16; G06N 20/00

(52) U.S. Cl. CPC B25J 9/163; G06N 20/00

(57) ABSTRACT

A control device 1A mainly includes an operation sequence generation means 17A. The operation sequence generation means 17A is configured to generate, based on recognition results Ra relating to types and states of objects present in a workspace where a robot which performs a task and another working body perform cooperative work, an operation sequence Sa to be executed by the robot.

### TECHNICAL FIELD

The present invention relates to a technical field of a control device, a control method, and a storage medium for performing process related to tasks to be performed by a robot.

### BACKGROUND ART

There is proposed such a control method to perform control of a robot necessary for executing the task when a task to be performed by a robot is given. For example, Patent Literature 1 discloses a robot controller configured, when placing a plurality of objects in a container by a robot with a hand for gripping an object, to determine possible orders of gripping the objects by the hand and to determine the order of the objects to be placed in the container based on the index calculated with respect to each of the possible orders.

### CITATION LIST

### Patent Literature

Patent Literature 1: JP 2018-51684A

### SUMMARY

### Problem to be Solved

When a robot performs a task, depending on the given task, it is necessary for the robot to perform the work in a common workspace with other robots or other workers. Patent Literature 1 is silent on how to determine the operation to be executed by the robot in this case.

In view of the above-described issue, it is therefore an example object of the present disclosure to provide a control device, a control method, and a storage medium capable of suitably generating an operation sequence of a robot.

### Means for Solving the Problem

In one mode of the control device, there is provided a control device including: an operation sequence generation means configured to generate, based on recognition results relating to types and states of objects present in a workspace where a robot which performs a task and another working body perform cooperative work, an operation sequence to be executed by the robot.

In one mode of the control method, there is provided a control method executed by a computer, the control method including: generating, based on recognition results relating to types and states of objects present in a workspace where a robot which performs a task and another working body perform cooperative work, an operation sequence to be executed by the robot.

In one mode of the storage medium, there is provided a storage medium storing a program executed by a computer, the program causing the computer to function as: an operation sequence generation means configured to generate, based on recognition results relating to types and states of objects present in a workspace where a robot which performs a task and another working body perform cooperative work, an operation sequence to be executed by the robot.

### Effect

An example advantage according to the present invention is to suitably generate an operation sequence of a robot when the robot performs a cooperative work with other working bodies.

### BRIEF DESCRIPTION OF THE DRAWINGS

FIG. 1 is a configuration of a robot control system.

FIG. 2 is a hardware configuration of a control device.

FIG. 3 illustrates an example of the data structure of application information.

FIG. 4 is an example of a functional block of the control device.

FIG. 5 is an example of a functional block of a recognition unit.

FIG. 6 is an example of a functional block of an operation sequence generation unit.

FIG. 7 is a bird's-eye view of a workspace.

FIG. 8 is an example of a flowchart showing an outline of the robot control process performed by the control device in the first example embodiment.

FIG. 9A is an example of a bird's-eye view of the workspace in the first application example.

FIG. 9B is an example of a bird's-eye view of the workspace in the second application example.

FIG. 9C is an example of a bird's-eye view of the workspace in the third application example.

FIG. 10 is an example of a flowchart showing an outline of the robot control process in a modification.

FIG. 11 is a schematic configuration diagram of a control device in the second example embodiment.

FIG. 12 is an example of a flowchart showing a procedure of the process executed by the control device in the second example embodiment.

### EXAMPLE EMBODIMENTS

Hereinafter, an example embodiment of a control device, a control method, and a storage medium will be described with reference to the drawings.

### First Example Embodiment

(1) System Configuration

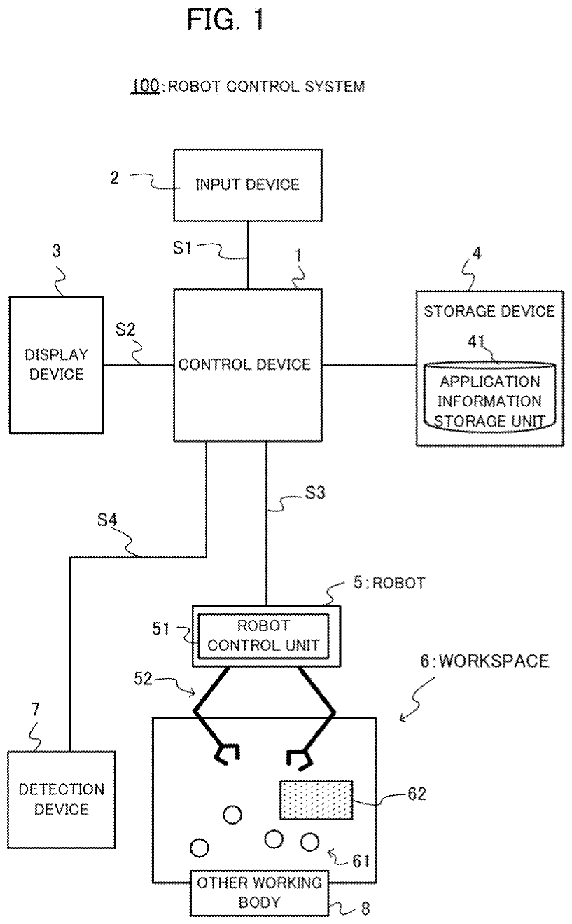

FIG. 1 shows a configuration of a robot control system 100 according to the first example embodiment. The robot control system 100 mainly includes a control device 1, an input device 2, a display device 3, a storage device 4, a robot 5, and a detection device 7.

When a task (also referred to as “objective task”) to be performed by the robot 5 is specified, the information processing device 1 converts the objective task into a time step sequence of simple tasks each of which the robot 5 can accept, and supplies the sequence to the robot 5. Hereafter, a simple task in units of command that can be accepted by the robot 5 is also referred to as “subtask” and a sequence of subtasks to be executed by each of the robots 5 in order to achieve the objective task is referred to as “subtask sequence”. The subtask sequence corresponds to an operation sequence which defines a series of operations to be executed by the robot 5.

The control device 1 performs data communication with the input device 2, the display device 3, the storage device 4, the robot 5 and the detection device 7 via a communication network or by wired or wireless direct communication. For example, the control device 1 receives an input signal “S1” for specifying the objective task from the input device 2. Further, the control device 1 transmits, to the display device 3, a display signal “S2” for performing a display relating to the task to be executed by the robot 5. Further, the control device 1 transmits a control signal “S3” relating to the control of the robot 5 to the robot 5. The control device 1 receives the detection signal “S4” from the detection device 7.

The input device 2 is an interface that accepts the input from the user and examples of the input device 2 include a touch panel, a button, a keyboard, and a voice input device. The input device 2 supplies an input signal S1 generated based on the user's input to the control device 1. The display device 3 displays information based on the display signal S2 supplied from the control device 1 and examples of the display device 3 include a display and a projector.

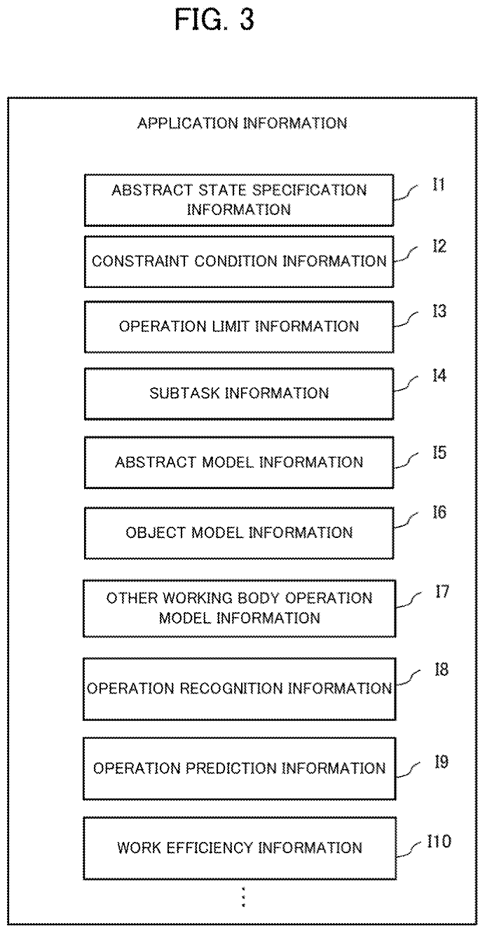

The storage device 4 includes an application information storage unit 41. The application information storage unit 41 stores application information necessary for generating a sequence of subtasks from the objective task. Details of the application information will be described later with reference to FIG. 3. The storage device 4 may be an external storage device such as a hard disk connected to or built in to the control device 1, or may be a storage medium such as a flash memory. The storage device 4 may be a server device that performs data communication with the control device 1. In this case, the storage device 4 may include a plurality of server devices.

The robot 5 performs, based on the control of the control device 1, cooperative work with the other working body 8. The robot 5 shown in FIG. 1 has, as an example, two robot arm 52 subjected to control each capable of gripping an object as a control object, and performs pick-and-place (picking up and moving process) of the target objects 61 present in the workspace 6. The robot 5 has a robot control unit 51. The robot control unit 51 performs operation control of each robot arm 52 based on a subtask sequence specified for each robot arm 52 by the control signal S3.

The workspace 6 is a workspace where the robot 5 performs cooperative work with the other working body 8. In the workspace 6 shown in FIG. 1, there are a plurality of target objects 61 to be worked by the robot 5, an obstacle 62 which is an obstacle in the work of the robot 5, the robot arms 52, and another working body 8 for performing work in cooperation with the robot 5. The other working body 8 may be a worker performing work with the robot 5 in the workspace 6, or may be a working robot performing work with the robot 5 in the workspace 6.

The detection device 7 is one or more sensors configured to detect the state of the workspace 6 and examples of the sensors include a camera, a range finder sensor, a sonar, and a combination thereof. The detection device 7 supplies the generated detection signal S4 to the control device 1. The detection signal S4 may be image data showing the workspace 6, or it may be a point cloud data indicating the position of objects in the workspace 6. The detection device 7 may be a self-propelled sensor or a flying sensor (including a drone) that moves within the workspace 6. Examples of the detection device 7 may also include a sensor provided in the robot 5, a sensor provided in the other working body 8, and a sensor provided at any other machine tool such as conveyor belt machinery present in the workspace 6. The detection device 7 may also include a sensor for detecting sounds in the workspace 6. Thus, the detection device 7 is a variety of sensors for detecting the state in the workspace 6, and it may be a sensor provided at any location.

It is noted that a marker or a sensor for performing the operation recognition (e.g., motion capture) of the other working body 8 may be provided at the other working body 8. In this case, the above-described marker or sensor is provided at one or more feature points that are characteristic points in the recognition of the operation executed by the other working body 8 such as joints and hands of the other working body 8. Examples of the detection device 7 include a sensor configured to detect the position of a marker of a feature point and a sensor provided at a feature point.

The configuration of the robot control system 100 shown in FIG. 1 is an example, and various changes may be performed to the configuration. For example, the robot 5 may be plural robots. Further, the robot 5 may include only one or three or more robot arms 52. Even in these cases, the control device 1 generates a subtask sequence to be executed for each robot 5 or each robot arm 52 based on the objective task, and transmits a control signal S3 indicating the subtask sequence to each robot 5. The detection device 7 may be a part of the robot 5. Further, the robot control unit 51 may be configured separately from the robot 5 or may be incorporated in the control device 1. Further, the input device 2 and the display device 3 may be included in the control device 1 (e.g., a tablet terminal) in such a state that they are incorporated in the control device 1. Further, the control device 1 may be configured by a plurality of devices. In this case, the plurality of devices that function as the control device 1 exchange information necessary to execute the pre-allocated process with one another. Further, the robot 5 may incorporate the function of the control device 1.

(2) Hardware Configuration of Control Device

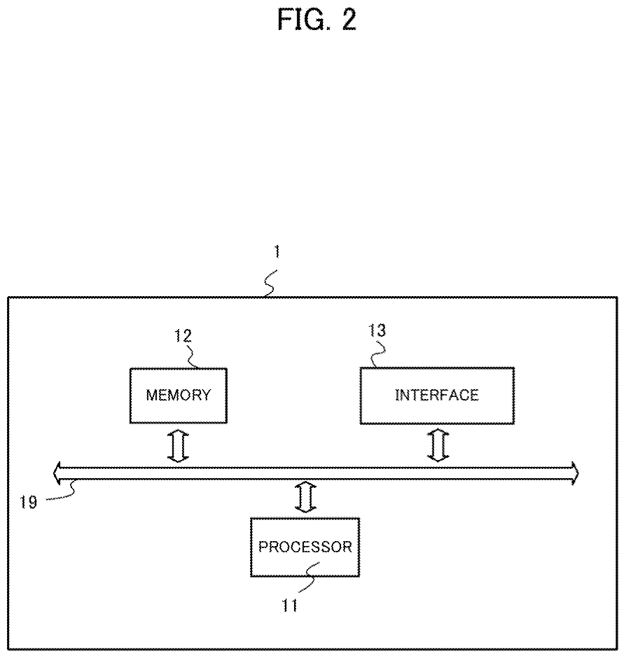

FIG. 2 shows a hardware configuration of the control device 1. The control device 1 includes, as hardware, a processor 11, a memory 12, and an interface 13. The processor 11, the memory 12, and the interface 13 are connected via a data bus 19 to one another.

The processor 11 executes a predetermined process by executing a program stored in the memory 12. The processor 11 is one or more processors such as a CPU (Central Processing Unit) and a GPU (Graphics Processing Unit).

The memory 12 is configured by various volatile and non-volatile memories such as a RAM (Random Access Memory) and a ROM (Read Only Memory). Further, the memory 12 stores a program for the control device 1 to execute a predetermined process. The memory 12 is used as a work memory and temporarily stores information acquired from the storage device 4. The memory 12 may function as a storage device 4. In contrasts, the storage device 4 may function as the memory 12 of the control device 1. The program executed by the control device 1 may be stored in a storage medium other than the memory 12.

The interface 13 is an interface for electrically connecting the control device 1 to other external devices. For example, the interface 13 includes an interface for connecting the control device 1 to the input device 2, an interface for connecting the control device to the display device 3, and an interface for connecting the control device 1 to the storage device 4. The interface 13 includes an interface for connecting the control device 1 to the robot 5, and an interface for connecting the control device 1 to the detection device 7. These connections may be wired connections and may be wireless connections. For example, the interface for connecting the control device 1 to these external devices may be a communication interface for wired or wireless transmission and reception of data to and from these external devices under the control of the processor 11. In another example, the control device 1 and the external devices may be connected by a cable or the like. In this case, the interface 13 includes an interface which conforms to an USB (Universal Serial Bus), a SATA (Serial AT Attachment), or the like for exchanging data with the external devices.

The hardware configuration of the control device 1 is not limited to the configuration shown in FIG. 2. For example, the control device 1 may include at least one of an input device 2, a display device 3, and a storage device 4. Further, the control device 1 may be connected to or incorporate a sound output device such as a speaker. In these cases, the control device 1 may be a tablet-type terminal or the like in which the input function and the output function are integrated with the main body.

(3) Application Information

Next, a data structure of the application information stored in the application information storage unit 41 will be described.

FIG. 3 shows an example of a data structure of application information stored in the application information storage unit 41. As shown in FIG. 3, the application information storage unit 41 includes abstract state specification information I1, constraint condition information I2, operation limit information I3, subtask information I4, abstract model information I5, object model information I6, other working body operation model information I7, operation recognition information I8, operation prediction information I9, and work efficiency information I10.

The abstract state specification information I1 specifies abstract states to be defined in order to generate the subtask sequence. The above-mentioned abstract states are abstract state of objects in the workspace 6, and are defined as propositions to be used in the target logical formula to be described later. For example, the abstract state specification information I1 specifies the abstract states to be defined for each type of objective task. The objective task may be various types of tasks such as pick-and-place, capture of moving object(s) and turn of a screw.

The constraint condition information I2 indicates constraint conditions of performing the objective task. The constraint condition information I2 indicates, for example, a constraint that the robot 5 (robot arm 52) must not be in contact with an obstacle when the objective task is pick-and-place, and a constraint that the robot arms 52 must not be in contact with each other, and the like. The constraint condition information I2 may be information in which the constraint conditions suitable for each type of the objective task are recorded.

The operation limit information I3 is information on the operation limit of the robot 5 to be controlled by the information processing device 1. For example, the operation limit information I3 in the case of the robot 5 shown in FIG. 1 is information that defines the maximum reaching speed by the robot arm 52.

The subtask information I4 indicates information on subtasks that the robot 5 can accept. For example, when the objective task is pick-and-place, the subtask information I4 defines a subtask “reaching” that is the movement of the robot arm 52, and a subtask “grasping” that is the grasping by the robot arm 52. The subtask information I4 may indicate information on subtasks that can be used for each type of objective task.

The abstract model information I5 is information on an abstract model in which the dynamics in the workspace 6 is abstracted. The abstract model is represented by a model in which real dynamics is abstracted by a hybrid system, as will be described later. The abstract model Information I5 includes information indicative of the switching conditions of the dynamics in the above-mentioned hybrid system. For example, one of the switching conditions in the case of the pick-and-place shown in FIG. 1 is that the target object 61 cannot be moved unless it is gripped by the hand of the robot arm 52. The abstract model information I5 includes information on an abstract model suitable for each type of the objective task. It is noted that information on the dynamic model in which the dynamics of the other working body 8 is abstracted is stored separately from the abstract model information I5 as the other working body operation model information I7 to be described later.

The object model information I6 is information relating to an object model of each object (in the example shown in FIG. 1, the robot arms 52, the objects 61, the other working body 8, the obstacle 62, and the like) to be recognized from the detection signal S4 generated by the detection device 7. For example, the object model information I6 includes: information which the control device 1 requires to recognize the type, the position, the posture, the ongoing (currently-executing) operation and the like of the each object described above; and three-dimensional shape information such as CAD (Computer Aided Design) data for recognizing the three-dimensional shape of the each object. The former information includes the parameters of an inference engine obtained by learning a learning model that is used in a machine learning such as a neural network. For example, the above-mentioned inference engine is learned in advance to output the type, the position, the posture, and the like of an object shown in the image when an image is inputted thereto.

The other working body operation model information I7 is information on the dynamic model in which the dynamics of the other working body 8 is abstracted. In the present example embodiment, the other working body operation model information I7 includes information indicating an abstract model (also referred to as “other working body operation model Mo1”) of the dynamics of each assumed operation to be executed by the other working body 8. For example, when the other working body 8 is a person (operator), the other working body operation model information I7 includes the other working body operation model Mo1 for each operation that can be performed by a person during the work such as running, walking, grasping an object, and changing the working position. Similarly, when the other working body 8 is a robot, the other working body operation model information I7 includes the other working body operation model Mo1 for each operation that a robot can do during the work. Each other working body operation model also has parameters that define the mode of operation, such as operation speed. There parameters have initial values, respectively, and are updated through the learning process by the control device 1 to be described later. The other working body operation model information I7 may be a database that records the other working body operation model Mo1 for each possible operation to be executed by the other working body 8.

The operation recognition information I8 stores information necessary for recognizing the operation executed by the other working body 8. For example, the operation recognition information I8 may be parameters of an inference engine learned to infer the operation executed by the other working body 8 when a predetermined number of time series images of the other working body 8 are inputted thereto. In another example, the operation recognition information 18 may be parameters of an inference engine learned to infer the operation executed by the other working body 8 when the time series data indicating the coordinate positions of a plurality of predetermined feature points of the other working body 8 is inputted thereto. The parameters of the inference engine in these cases are obtained, for example, by training a learning model based on deep learning, a learning model based on other machine learning such as a support vector machine, or a learning model of the combination thereof. The inference engine described above may be learned for each type of the other working body 8 or/and for each type of the objective task. In this case, the operation recognition information I8 includes the information indicative of the parameters of the inference engine learned in advance for each type of the other working body 8 or/and for each type of the objective task.

The operation prediction information I9 is information necessary to predict the operation executed by the other working body 8. Specifically, the operation prediction information I9 is information for specifying, based on the ongoing (current) operation executed by the other working body 8 or the past operation sequence including the current operation executed by the other working body 8, the following operation or the following operation sequence to be executed next by the other working body 8. The operation prediction information I9 may be a look-up table or may be parameters of an inference engine obtained by machine learning. In another example, when the other working body 8 is a robot that performs repetitive operation, the operation prediction information I9 may be information indicating the operation to be repeated and its cycle period. The operation prediction information I9 may be stored in the application information storage unit 41 for each type of the objective task and/or for each type of the other working body 8. In addition, the operation prediction information I9 may be generated by the learning process to be described later, which is executed by the control device 1, instead of being previously stored in the application information storage unit 41.

The work efficiency information I10 is information indicating the work efficiency of the other working body 8 present in the workspace 6. This work efficiency is represented by a numerical value having a predetermined value range. The work efficiency information I10 may be stored in advance in the application information storage unit 41 or may be generated by a learning process to be described later executed by the control device 1. In some embodiments, the work efficiency information I10 is used for such an objective task that there are multiple other working bodies 8 and that the work progresses of the other working bodies 8 need to be synchronized due to the work relation among the other working bodies 8. Therefore, in the case where the other working body 8 is a single or in the case of the objective task in which the work progress of the other working body 8 does not need to be synchronized, the application information storage unit 41 does not need to store the work efficiency information I10.

In addition to the information described above, the application information storage unit 41 may store various kinds of information related to the generation process of the subtask sequence.

(4) Process Overview of Control Unit

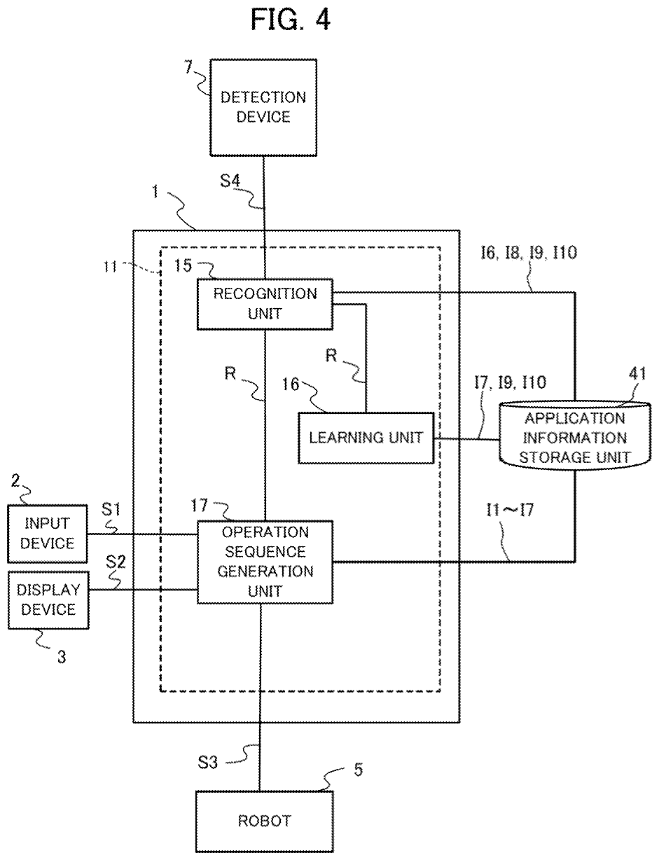

FIG. 4 is an example of a functional block showing an outline of the process executed by the control device 1. The processor 11 of the control device 1 functionally includes a recognition unit 15, a learning unit 16, and an operation sequence generation unit 17. In FIG. 4, an example of data to be transmitted and received between the blocks is shown, but it is not limited thereto. The same applies to diagrams of other functional blocks to be described later.

The recognition unit 15 analyzes the detection signal S4 by referring to the object model information I6, the operation recognition information I8, and the operation prediction information 19, and thereby recognizes the states of objects (including the other working body 8 and the obstacle) present in the workspace 6 and the operation executed by the other working body 8. Further, the recognition unit 15 refers to the work efficiency information I10 and thereby recognizes the work efficiency of the other working body 8. Then, the recognition unit 15 supplies the recognition result “R” recognized by the recognition unit 15 to the learning unit 16 and the operation sequence generation unit 17, respectively. It is noted that the detection device 7 may be equipped with the function corresponding to the recognition unit 15. In this case, the detection device 7 supplies the recognition result R to the control device 1.

The learning unit 16 updates the other working body operation model information I7, the operation prediction information I9, and the work efficiency information I10 by learning the operation executed by the other working body 8 based on the recognition result R supplied from the recognition unit 15.

First, a description will be given on the update of the other working body operation model information I7. The learning unit 16 learns the parameters relating to the operation executed by the other working body 8 recognized by the recognition unit 15 based on the recognition result R transmitted from the recognition unit 15 in time series. The parameters include any parameter that defines the operation, and examples of the parameters include speed information, acceleration information, and information on the angular velocity of the operation. In this case, the learning unit 16 may learn the parameters of the operation by statistical process based on the recognition result R representing the multiple times data of an operation. In this case, the learning unit 16 calculates each parameter of the operation executed by the other working body 8 recognized by the recognition unit 15 by a predetermined number of times, and calculates a representative value of the each parameter such as an average of the calculated values corresponding to the calculated predetermined number of the each parameter. Then, based on the learning result, the learning unit 16 updates the other working body operation model information I7 which is later referred to by the operation sequence generation unit 17. Thereby, the parameters of the other working body operation model Mo1 are suitably learned.

Next, a description will be given of the update of the operation prediction information I9. If the learning unit 16 recognizes, based on the recognition result R sent from the recognition unit 15 in time series, that the other working body 8 is periodically performing an operation sequence, the learning unit 16 stores information on the operation sequence periodically executed, as the operation prediction information I9 regarding the other working body 8, in the application information storage unit 41.

The update of the work efficiency information I10 will be described. In a case where there are a plurality of other work bodies 8, the learning unit 16 determines the work efficiency indicating the work progress (degree of progress) of each other working body 8 on the basis of the recognition result R transmitted from the recognition unit 15 in time series. Here, when each other working body 8 repeatedly executes one or more operations, the learning unit 16 measures a time required to execute the one or more operations for one period. Then, the learning unit 16 increases the work efficiency of the other working body 8 with decrease in the above-mentioned time required for the other working body 8 to execute the one or more operations.

The operation sequence generation unit 17 generates a subtask sequence to be executed by the robot 5 based on the objective task specified by the input signal S1, the recognition result R supplied from the recognition unit 15, and various types of application information stored in the application information storage unit 41. In this case, as will be described later, the operation sequence generation unit 17 determines an abstract model of the dynamics of the other working body 8 based on the recognition result R, and generates an abstract model in the whole workspace 6 including the other working body 8 and the robot 5. Thereby, the operation sequence generation unit 17 suitably generates a subtask sequence for causing the robot 5 to execute the cooperative work with the other working body 8. Then, the operation sequence generation unit 17 transmits the control signal S3 indicating at least the generated subtask sequence to the robot 5. Here, the control signal S3 includes information indicating the execution order and execution timing of each subtask included in the subtask sequence. Further, when accepting the objective task, the operation sequence generation unit 17 transmits the display signal S2 for displaying a view for inputting the objective task to the display device 3, thereby causing the display device 3 to display the above-described view.

Each component of the recognition unit 15, the learning unit 16, and the operation sequence generation unit 17 described in FIG. 4 can be realized, for example, by the processor 11 executing the program. More specifically, each component may be implemented by the processor 11 executing a program stored in the memory 12 or the storage device 4. In addition, the necessary programs may be recorded in any nonvolatile recording medium and installed as necessary to realize each component. Each of these components is not limited to being implemented by software using a program, and may be implemented by any combination of hardware, firmware, and software. Each of these components may also be implemented using user programmable integrated circuit, such as, for example, FPGA (field-programmable gate array) or a microcomputer. In this case, the integrated circuit may be used to realize a program to function as each of the above-described components. Thus, each component may be implemented by hardware other than the processor. The above is the same in other example embodiments to be described later.

(5) Details of Recognition Unit

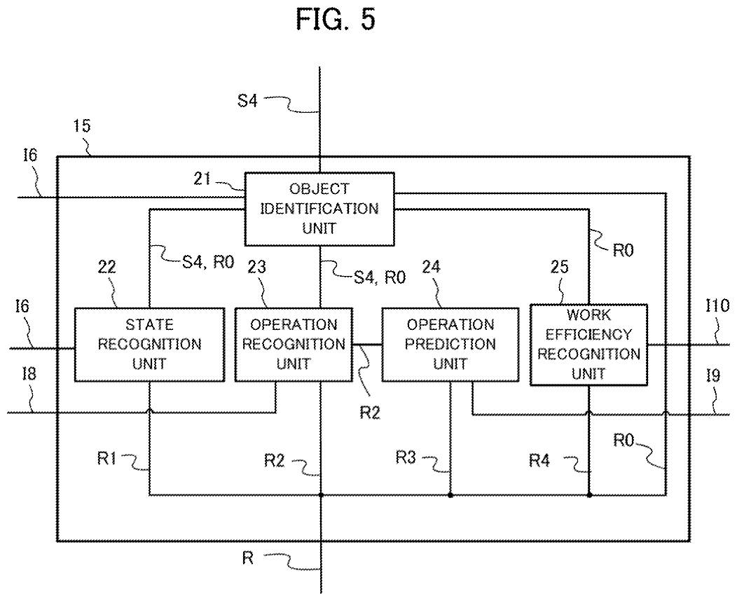

FIG. 5 is a block diagram showing a functional configuration of the recognition unit 15. The recognition unit 15 functionally includes an object identification unit 21, a state recognition unit 22, an operation recognition unit 23, an operation prediction unit 24, and a work efficiency recognition unit 25.

The object identification unit 21 identifies objects present in the workspace 6 based on the detection signal S4 supplied from the detection device 7 and the object model information I6. Then, the object identification unit 21 supplies the object identification result “R0” and the detection signal S4 to the state recognition unit 22 and the operation recognition unit 23, and supplies the object identification result R0 to the work efficiency recognition unit 25. Further, the object identification unit 21 supplies the object identification result R0 to the operation sequence generation unit 17 as a part of the recognition result R.

Here, the identification of the objects by the object identification unit 21 will be supplementally described. The object identification unit 21 recognizes the presence of various objects existing in the workspace 6 such as the robot 5 (the robot arms 52 in FIG. 1), the other working body 8, objects handled by the robot 5 and/or the other working body 8, a target object such as pieces of a product, and obstacles. Here, when a marker is attached to each object existing in the workspace 6, the object identification unit 21 may identify each object in the workspace 6 by specifying the marker based on the detection signal S4. In this case, the marker may have different attributes (e.g., color or reflectance) for each object to be attached. In this case, the object identification unit 21 identifies the objects to which markers are attached respectively based on the reflectance or the color specified from the detection signal S4. The object identification unit 21 may perform identification of the objects existing in the workspace 6 using a known image recognition process or the like without using the marker described above. For example, when the parameters of an inference engine learned to output the type of an object shown in the input image is stored in the object model information I6, the object identification unit 21 inputs the detection signal S4 to the inference engine, thereby identifies an object in the workspace 6.

The state recognition unit 22 recognizes the states of the objects present in the workspace 6 based on the detection signal S4 obtained in time series. For example, the state recognition unit 22 recognizes the position, posture, speed (e.g., translational speed, angular velocity vector) of a target object subject to operation by the robot 5 and an obstacle. Further, the state recognition unit 22 recognizes the position, the posture, and the speed of the feature points such as a joint of the other working body 8.

Here, when the marker is attached for each feature point of the other working body 8, the state recognition unit 22 detects each feature point of the other working body 8 by specifying the marker based on the detection signal S4. In this case, the state recognition unit 22 refers to the object model information I6 indicating the positional relation among the feature points and then identifies each feature point of the other working body 8 from a plurality of marker positions specified by the detection signal S4. The state recognition unit 22 may detect, using an image recognition process or the like, each feature point of the other working body 8 to which the above-described marker is not attached. In this case, the state recognition unit 22 may input the detection signal S4, which is an image, to an inference engine configured with reference to the object model information I6, and specify the position and the posture of each feature point based on the output from the inference engine. In this case, the inference engine is learned to output, when the detection signal S4 that is an image of the other working body 8 is inputted thereto, the position and the posture of a feature point of the other working body 8. Furthermore, the state recognition unit 22 calculates the speed of the feature point based on the time series data indicating the transition of the position of the feature point identified described above.

The state recognition unit 22 supplies the state recognition result “R1” which is the recognition result of the states of the objects present in the workspace 6 and which is generated by the state recognition unit 22 to the operation sequence generation unit 17 as a part of the recognition result R.

The operation recognition unit 23 recognize the operation executed by the other working body 8 based on the operation recognition information I8 and the detection signal S4. For example, when time series images of the other working body 8 are included in the detection signal S4, the operation recognition unit 23 infers the operation executed by the other working body 8 by inputting the time series images to an inference engine configured based on the operation recognition information I8. In another example, the operation recognition unit 23 may recognize the operation executed by the other working body 8 based on the state recognition result R1 outputted by the state recognition unit 22. In this case, the operation recognition unit 23 acquires time series data indicating the coordinate positions of a predetermined number of the feature points of the other working body 8 based on the state recognition result R1. Then, the operation recognition unit 23 infers the operation executed by the other working body 8 by inputting the time series data to an inference engine configured based on the operation recognition information I8. Then, the operation recognition unit 23 supplies the operation recognition result “R2” indicating the recognized operation executed by the other working body 8 to the operation prediction unit 24, and also supplies it as a part of the recognition result R to the operation sequence generation unit 17. The operation recognition unit 23 may recognize the operation of each hand when the other working body 8 performs work by both hands.

The operation prediction unit 24 predicts the operation to be executed by the other working body 8 based on the operation prediction information I9 and the operation recognition result R2. In this case, the operation prediction unit 24 determines, from most recent one or more operations indicated by the operation recognition result R2, the predicted operation or operation sequence of the other working body 8 by using the operation prediction information I9 indicating a look-up table, an inference engine, knowledge base or the like. It is noted that the operation prediction unit 24 may predict the operation of each hand when the other working body 8 performs work by both hands. Then, the operation prediction unit 24 supplies the predicted operation recognition result “R3” indicating the predicted operation (operation sequence) of the other working body 8 to the operation sequence generation unit 17 as a part of the recognition result R. When the operation prediction unit 24 cannot predicts the operation, the operation prediction unit 24 may not have to supply the predicted operation recognition result R3 to the operation sequence generation unit 17 or may supply the predicted operation recognition result R3 indicating that the operation could not be predicted to the operation sequence generation unit 17.

When the work efficiency recognition unit 25 determines that there are a plurality of other working bodies 8 based on the object identification result R0 supplied from the object identification unit 21, the work efficiency recognition unit 25 recognizes the work efficiency of each other working body 8 by referring to the work efficiency information I10. Then, the work efficiency recognition unit 25 supplies the work efficiency recognition result “R4” indicating the work efficiency of each other working body 8 to the operation sequence generation unit 17 as a part of the recognition result R.

(6) Details of Operation Sequence Generation Unit

Next, the details of the process executed by the operation sequence generation unit 17 will be described.

(6-1) Functional Block

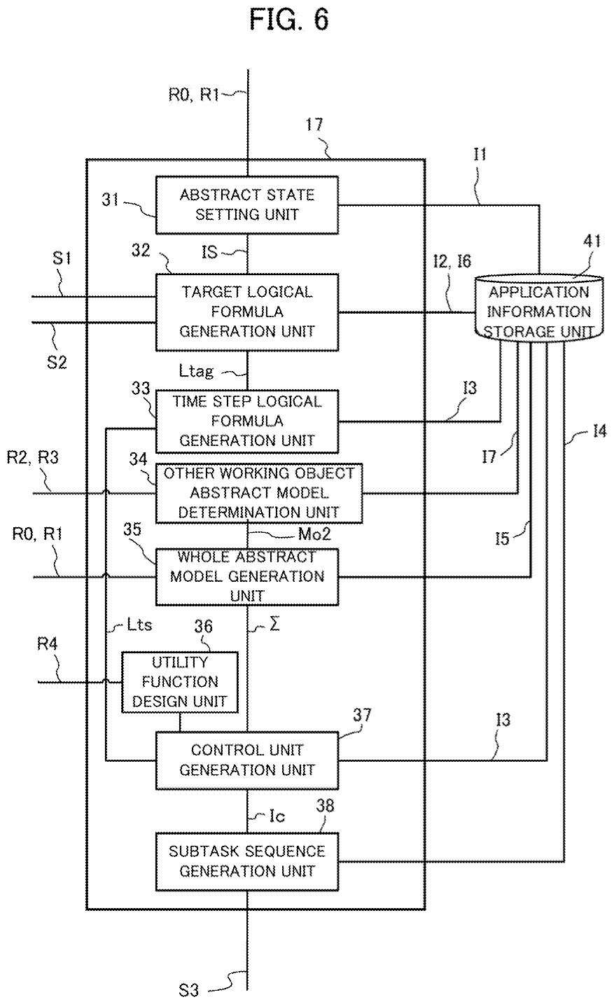

FIG. 6 is an example of a functional block showing the functional configuration of the operation sequence generation unit 17. The operation sequence generation unit 17 functionally includes an abstract state setting unit 31, a target logical formula generation unit 32, a time step logical formula generation unit 33, an other working body abstract model determination unit 34, a whole abstract model generation unit 35, a utility function design unit 36, a control input generation unit 37, and a subtask sequence generation unit 38.

Based on the object identification result R0 and the state recognition result R1 supplied from the recognition unit 15 and the abstract state specification information I1 acquired from the application information storage unit 41, the abstract state setting unit 31 sets abstract states in the workspace 6 that needs to be considered when executing the objective task. In this case, the abstract state setting unit 31 defines a proposition of each abstract state to be expressed in a logical formula. The abstract state setting unit 31 supplies information (also referred to as “abstract state setting information I5”) indicating the set abstract states to the target logical formula generation unit 32.

When receiving the input signal S1 relating to the objective task from the input device 2, on the basis of the abstract state setting information I5, the target logical formula generation unit 32 converts the objective task indicated by the input signal S1 into a logical formula (also referred to as a “target logical formula Ltag”), in the form of the temporal logic, representing the final state to be achieved. In this case, by referring to the constraint condition information I2 from the application information storage unit 41, the target logical formula generation unit 32 adds the constraint conditions to be satisfied in executing the objective task to the target logical formula Ltag. Then, the target logical formula generation unit 32 supplies the generated target logical formula Ltag to the time step logical formula generation unit 33. Further, the target logical formula generation unit 32 generates a display signal S2 for displaying a view for receiving an input relating to the objective task, and supplies the display signal S2 to the display device 3.

The time step logical formula generation unit 33 converts the target logical formula Ltag supplied from the target logical formula generation unit 32 to the logical formula (also referred to as “time step logical formula Lts”) representing the state at each time step. Then, the time step logical formula generation unit 33 supplies the generated time step logical formula Lts to the control input generation unit 37.

The other working body abstract model determination unit 34 determines a model (also referred to as “other working body abstract model Mo2”) which abstractly represents the dynamics of the other working body 8 on the basis of the operation recognition result R2 and the predicted operation recognition result R3 supplied from the recognition unit 15 and the other working body operation model information I7.

Here, a description will be given of an approach for determining the other workspace abstract model Mo2. First, the other working body abstract model determination unit 34 acquires, from the other working body operation model information I7, the other working body operation models Mo1 corresponding to the respective operations indicated by the operation recognition result R2 and the predicted operation recognition result R3. Then, the other working body abstract model determination unit 34 determines the other working body abstract model Mo2 based on the acquired other working body operation models Mo1. Here, when only one other working body operation model Mo1 is acquired (i.e., when only one operation is recognized by the recognition unit 15), the other working body abstract model determination unit 34 determines the other working body abstract model Mo2 to be the other working body operation model Mo1 corresponding to the single operation. In addition, when multiple other working body operation models Mo1 are acquired (i.e., when the ongoing operation and one or more predicted operations are recognized by the recognition unit 15), the other working body abstract model determination unit 34 determines the other working body abstract model Mo2 to be a model in which the acquired other working body operation models Mo1 are combined in time series. In this case, the other working body abstract model determination unit 34 determines the other working body abstract model Mo2 so that the other working body operation model Mo1 corresponding to each operation is applied during each time period in which the each operation by the other working body 8 is predicted to be performed.

The whole abstract model generation unit 35 generates a whole abstract model “Σ” in which the real dynamics in the workspace 6 is abstracted, based on the object identification result R0, the state recognition result R1, and the predicted operation recognition result R3 supplied from the recognition unit 15, the abstract model information I5 stored in the application information storage unit 41, and the other working body abstract model Mo2. In this case, the whole abstract model generation unit 35 considers the target dynamics as a hybrid system in which the continuous dynamics and the discrete dynamics are mixed, and generates the whole abstract model Σ based on the hybrid system. The method for generating the whole abstract model Σ will be described later. The whole abstract model generation unit 35 supplies the generated whole abstract model Σ to the control input generation unit 37.

The utility function design unit 36 designs a utility function to be used for the optimization process executed by the control input generation unit 37 on the basis of the work efficiency recognition result R4 supplied from the recognition unit 15. Specifically, when there are a plurality of other work bodies 8, the utility function design unit 36 sets the parameters of the utility function so as to weight the utility for the work by each of the other working bodies 8 based on the work efficiency of each of the other working bodies 8.

The control input generation unit 37 determines a control input to the robot 5 for each time step so that the time step logic formula Lts supplied from the time step logical formula generation unit 33 and the whole abstract model Σ supplied from the whole abstract model generation unit 35 are satisfied and so that the utility function designed by the utility function design unit 36 is optimized. Then, the control input generation unit 37 supplies information (also referred to as “control input information Ic”) indicating the control input to the robot 5 for each time step to the subtask sequence generation unit 38.

The subtask sequence generation unit 38 generates a subtask sequence based on the control input information Ic supplied from the control input generation unit 37 and the subtask information I4 stored in the application information storage unit 41, and supplies the control signal S3 indicating the subtask sequence to the robot 5.

(6-2) Details of Abstract State Setting Unit

The abstract state setting unit 31 sets abstract states in the workspace 6 based on the object identification result R0 and the state recognition result R1 supplied from the recognition unit 15 and the abstract state specification information I1 acquired from the application information storage unit 41. In this case, the abstract state setting unit 31 refers to the abstract state specification information I1 and recognizes abstract states to be set in the workspace 6. The abstract states to be set in the workspace 6 varies depending on the type of the objective task. Therefore, when the abstract states to be set are defined for each type of the objective task in the abstract state specification information I1, the abstract state setting unit 31 refers to the abstract state specification information I1 corresponding to the objective task specified by the input signal S1 and recognizes the abstract states to be set.

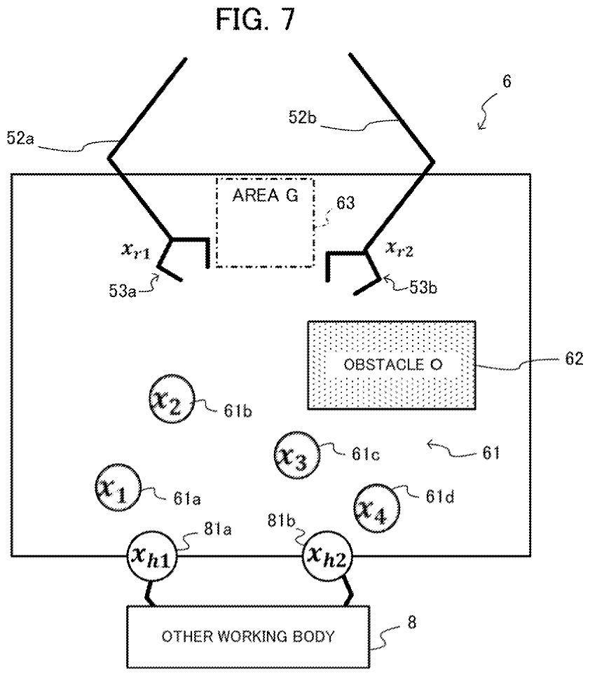

FIG. 7 shows a bird's-eye view of the workspace 6. In the workspace 6 shown in FIG. 7, there are two robot arms 52a and 52b, four target objects 61 (61a to 61d), an obstacle 62, and the other working body 8 having other working body hands 81 (81a and 81b).

In this case, based on the object identification result R0 and the state recognition result R1 which are the recognition results generated by the recognition unit 15 by use of the detection signal S4 outputted by the detection device 7, the abstract state setting unit 31 recognizes the state of the target object 61, the presence range of the obstacle 62, the state of the other working body 8, the presence range of the area G set as a goal point, and the like.

Here, the abstract state setting unit 31 recognizes the position vectors “x₁” to “x₄” indicative of the centers of the target objects 61a to 61d as the positions of the target objects 61a to 61d, respectively. Further, the abstract state setting unit 31 recognizes the position vector “xᵣ₁” of the robot hand 53a for grasping a target object as the position of the robot arm 52a and the position vector “xᵣ₂” of the robot hand 53b for grasping a target object as the position of the robot arm 52b.

Further, the abstract state setting unit 31 recognizes the position vector “xₕ₁” of the other working body hand 81a, which is one hand of the other working body 8, and the position vector “x_{b2}” of the other working body hand 81b, which is the other hand of the other working body 8, as the positions of the feature points relating to various operations by the other working body 8 such as grabbing, releasing, and moving the target object. The abstract state setting unit 31 may determine the other working body hand 81a and the other working body hand 81b to be two other working bodies 8 independent from each other. In this case, the abstract state setting unit 31 recognizes each position of the other working body hand 81a and the other working body hand 81b as the positions of the other working bodies 8.

Similarly, the abstract state setting unit 31 recognizes the postures of the target objects 61a to 61d (it is unnecessary in the example of FIG. 7 because each target object is spherical), the presence range of the obstacle 62, the presence range of the area G, and the like. For example, when assuming that the obstacle 62 is a rectangular parallelepiped and the area G is a rectangle, the abstract state setting unit 31 recognizes the position vector of each vertex of the obstacle 62 and the area G.

The abstract state setting unit 31 determines each abstract state to be defined in the objective task by referring to the abstract state specification information I1. In this case, the abstract state setting unit 31 determines a proposition indicating the each abstract state on the basis of the recognition result (e.g., the number of the objects and the area(s) and the type thereof) relating to the objects and the area(s) present in the workspace 6 indicated by the object identification result R0 and the state recognition result R1 and the abstract state specification information I1.

In the example shown in FIG. 7, the abstract state setting unit 31 assigns identification labels “1” to “4” to the target objects 61a to 61d specified by the object identification result R0, respectively. Further, the abstract state setting unit 31 defines a proposition “gᵢ” that the target object “i” (i=1 to 4) is present in the area G (see the broken line frame 63) that is the goal point to be finally placed. Further, the abstract state setting unit 31 defines an identification label “O” to the obstacle 62, and defines the proposition “oᵢ” that the target object i interferes with the obstacle O. Furthermore, the abstract state setting unit 31 defines a proposition “h” that a robot arm 52 interferes with another robot arm 52. Similarly, the abstract state setting unit 31 defines a proposition that a robot arm 52 interferes with any of other working body hands 81a and 81b.

In this way, by referring to the abstract state specification information I1, the abstract state setting unit 31 recognizes the abstract state to be defined, and defines the propositions (gᵢ, oᵢ, h in the above-described example) representing the abstract state according to the number of the target objects 61, the number of the robot arms 52, the number of the obstacles 62, the number of the other working bodies 8 and the like. The abstract state setting unit 31 supplies the target logical formula generation unit 32 with the abstract state setting information I5 which includes the information indicative of the propositions representing the abstract state.

(6-3) Target Logical Formula Generation Unit

The target logical formula generation unit 32 converts the objective task specified by the input signal S1 into a logical formula using the temporal logic. It is noted that there are various existing technologies for the method of converting tasks expressed in natural language into logical formulas. For example, in the example of FIG. 7, it is herein assumed that the objective task “the target object (i=2) is finally present in the area G” is given. In this case, the target logical formula generation unit 32 generates the logical formula “⋄g₂” which represents the objective task by using the operator “⋄” corresponding to “eventually” of the linear logical formula (LTL: Linear Temporal Logic) and the proposition “gᵢ” defined by the abstract state setting unit 31. The target logical formula generation unit 32 may express the logical formula by using any operators based on the temporal logic other than the operator “⋄” such as logical AND “∧”, logical OR “∨”, negative “¬”, logical implication “⇒”, always “□”, next “∘”, until “U”, etc.). The logical formula may be expressed by any temporal logic other than linear temporal logic such as MTL (Metric Temporal Logic) and STL (Signal Temporal Logic).

Next, the target logical formula generation unit 32 generates the target logical formula Ltag obtained by adding the constraint conditions indicated by the constraint condition information 12 to the logical formula indicating the objective task.

For example, provided that two constraint conditions “the robot arms 52 does not interfere with each other” and “the target object i does not interfere with the obstacle O” for pick-and-place are included in the constraint condition information I2, the target logical formula generation unit 32 converts these constraint conditions into logical formulas. Specifically, the target logical formula generation unit 32 converts the above-described two constraint conditions into the following logical formulas by using the proposition “oᵢ” and the proposition “h” defined by the abstract state setting unit 31 according to the description relating to FIG. 7.

□¬h

∧ᵢ□¬∘ᵢ

Therefore, in this case, the target logical formula generation unit 32 generates the following target logical formula Ltag obtained by adding the logical formulas of these constraint conditions to the logical formula “⋄g₂” corresponding to the objective task “the target object (i=2) is eventually present in the area G”.

(⋄g₂)∧(□¬h)∧(∧ᵢ□¬∘ᵢ)

In practice, the constraint conditions corresponding to the pick-and-place are not limited to the above-described two constraint conditions and there are other constraint conditions such as “a robot arm 52 does not interfere with the obstacle O”, “plural robot arms 52 do not grasp the same target object”, “target objects does not contact with each other”, and “a robot arm 52 does not interfere with any of the other working body hands 81a and 81b”. Such constraint conditions are also stored in the constraint condition information I2 and are reflected in the target logical formula Ltag.

(6-4) Time Step Logical Formula Generation Unit

The time step logical formula generation unit 33 determines the number of time steps (also referred to as the “target time step number”) for completing the objective task, and determines combinations of propositions representing the state at each time step such that the target logical formula Ltag is satisfied with the target time step number. Since the combinations are normally plural, the time step logical formula generation unit 33 generates a logical formula obtained by combining these combinations by logical OR as the time step logical formula Lts. Each of the combinations described above is a candidate of a logical formula representing a sequence of operations to be instructed to the robot 5, and therefore it is hereinafter also referred to as “candidate φ”.

Here, a description will be given of a specific example of the processing executed by the time step logical formula generation unit 33 when the objective task “the target object (i=2) eventually exists in the area G” is set according to the description relating to FIG. 7.

In this case, the following target logical formula Ltag is supplied from the target logical formula generation unit 32 to the time step logical formula generation unit 33.

(⋄g₂)∧(□¬h)∧(∧ᵢ□¬∘ᵢ)

In this case, the time-step logical formula generation unit 33 uses the proposition “g_{i,k}” that is the extended proposition “gᵢ” to include the concept of time steps. Here, the proposition “g_{i,k}” is the proposition that the target object i exists in the area G at the time step k. Here, when the target time step number is set to “3”, the target logical formula Ltag is rewritten as follows.

(⋄_{g 2,3})∧(∧_{k=1,2,3}□¬hₖ)∧(∧_{i,k=1,2,3}□¬∘ᵢ)

⋄g_{2, 3} can be rewritten as shown in the following expression.

$$◇ {g}_{2 , 3} = ( ¬ {g}_{2 , 1} ⋀ ¬ {g}_{2 , 2} ⋀ {g}_{2 , 3} ) ⋁ ( ¬ {g}_{2 , 1} ⋀ {g}_{2 , 2} ⋀ {g}_{2 , 3} ) ⋁ ( {g}_{2 , 1} ⋀ ¬ {g}_{2 , 2} ⋀ {g}_{2 , 3} ) ⋁ ( {g}_{2 , 1} ⋀ {g}_{2 , 2} ⋀ {g}_{2 , 3} )$$

The target logical formula Ltag described above is represented by a logical OR (φ₁∨φ₂ ∨φ₃∨φ₄) of four candidates “φ₁” to “φ₄” as shown in below.

ϕ₁=(¬g_{2,1}∧¬g_{2,2}∧g_{2,3})∧(∧_{k=1,2,3}□¬hₖ)∧(∧_{i,k=1,2,3}□¬∘_{i,k})

ϕ₂=(¬g_{2,1}∧g_{2,2}∧g_{2,3})∧(∧_{k=1,2,3}□¬hₖ)∧(∧_{i,k=1,2,3}□¬∘_{i,k})

ϕ₃=(g_{2,1}∧¬g_{2,2}∧g_{2,3})∧(∧_{k=1,2,3}□¬hₖ)∧(∧_{i,k=1,2,3}□¬∘_{i,k})

ϕ₄=(g_{2,1}∧g_{2,2}∧g_{2,3})∧(∧_{k=1,2,3}□¬hₖ)∧(∧_{i,k=1,2,3}□¬∘_{i,k})

Therefore, the time-step logical formula generation unit 33 defines the logical OR of the four candidates φ₁ to φ₄ as the time-step logical formula Lts. In this case, the time step logical formula Lts is true if at least one of the four candidates φ₁ to φ₄ is true.

Next, a supplementary description will be given of a method for setting the number of target time steps.

For example, the time step logical formula generation unit 33 determines the target time step number based on the prospective (expected) work time designated by the user input. In this case, the time step logical formula generation unit 33 calculates the target time step number based on the prospective work time described above and the information on the time width per time step stored in the memory 12 or the storage device 4. In another example, the time step logical formula generation unit 33 stores, in advance in the memory 12 or the storage device 4, information in which a suitable target time step number is associated with each type of objective task, and determines the target time step number in accordance with the type of objective task to be executed by referring to the information.

In some embodiments, the time step logical formula generation unit 33 sets the target time step number to a predetermined initial value. Then, the time step logical formula generation unit 33 gradually increases the target time step number until the time step logical formula Lts with which the control input generation unit 35 can determine the control input is generated. In this case, if the control input generation unit 35 ends up not being able to derive the optimal solution in the optimization process with the set target time step number, the time step logical formula generation unit 33 add a predetermined number (1 or more integers) to the target time step number.

At this time, the time step logical formula generation unit 33 may set the initial value of the target time step number to a value smaller than the number of time steps corresponding to the work time of the objective task expected by the user. Thus, the time step logical formula generation unit 33 suitably suppresses setting the unnecessarily large target time step number.

(6-5) Other Working body Abstract Model Determination Unit and Whole Abstract Model Generation Unit

The whole abstract model generation unit 35 generates the whole abstract model Σ based on the other working body abstract model Mo2, the abstract model information I5, the object identification result R0, and the state recognition result R1. Here, in the abstract model information I5, the information necessary for the generation of the whole abstract model Σ is recorded for each type of the objective task. For example, when the objective task is a pick-and-place, an abstract model in a general format that does not specify the position or the number of the target objects, the position of the area where the target objects are placed, the number of robots 5 (or the number of robot arms 52), and the like is recorded in the abstract model information I5. Then, the whole abstract model generation unit 35 generates the whole abstract model Σ obtained by reflecting the object identification result R0, the state recognition result R1, and the other working body abstract model Mo2 in the abstract model in the general format which is indicated by the abstract model information I5 and which includes the dynamics of the robot 5. Accordingly, the whole abstract model Σ is a model in which the states of objects in the workspace 6, the dynamics of the robot 5, and the dynamics of the other working body 8 are abstractly represented. It is noted that examples of the states of the objects in the workspace 6 in the case of pick-and-place include the position of the objects, the number of the objects, the position of the area where the objects are placed, and the number of robots 5.

Here, at the time of work of the objective task by the robot 5, the dynamics in the workspace 6 is frequently switched. For example, in the case of pick-and-place, while the robot arm 52 is gripping the target object i, the target object i can be moved. However, if the robot arm 52 is not gripping the target object i, the target object i cannot be moved.

In view of the above, in the present example embodiment, in the case of pick-and-place, the operation of grasping the target object i is abstracted by the logical variable “δᵢ”. In this case, for example, the whole abstract model generation unit 35 can define the abstract model Σ to be set for the workspace 6 shown in FIG. 7 as the following equation (1).

$${[ \begin{matrix}{x}_{r 1} \\ {x}_{r 2} \\ {x}_{1} \\ ⋮ \\ {x}_{4} \\ {x}_{h 1} \\ {x}_{h 2}\end{matrix} ]}_{k + 1} = {[ \begin{matrix}I & A\end{matrix} ] [ \begin{matrix}{x}_{r 1} \\ {x}_{r 2} \\ {x}_{1} \\ ⋮ \\ {x}_{4} \\ {x}_{h 1} \\ {x}_{h 2}\end{matrix} ]}_{k} + [ \begin{matrix}I & & 0 \\ 0 & & I \\ {δ}_{1 , 1} I & & {δ}_{2 , 1} I \\ ⋮ & & ⋮ \\ {δ}_{1 , 4} I & & {δ}_{2 , 4} I \\ & O & \end{matrix} ] [ \begin{matrix}{u}_{1} \\ {u}_{2}\end{matrix} ] \qquad ( 1 )$$

$${h}_{{ij}_{min}} ( 1 - {δ}_{i} ) \leq {h}_{ij} ( x ) \leq {{h}_{ij}}_{max} {δ}_{i} + ( {δ}_{i} - 1 ) ε$$

Here, “uⱼ” indicates a control input for controlling the robot hand j (“j=1” is the robot hand 53a, “j=2” is the robot hand 53b), and “I” indicates a unit matrix. “0” indicates a zero matrix. “A” is a drift term representing the dynamics of the other working body hands 81 of the other working body 8, and the details will be described later. It is assumed that the control input is a speed as an example, but it may be an acceleration. Further, “δ_{j,i}” is a logical variable that is set to “1” when the robot hand j grasps the target object i and is set to “0” in other cases. Each of “xᵣ₁” and “xᵣ₂” indicates the position vector of the robot hand j, each of “x₁” to “x₄” indicates the position vector of the target object i, and each of “xₕ₁” and “xₕ₂” indicates the position vector of the other working body hand 81. Further, “h(x)” is a variable to be “h(x)>=0” when the robot hand exists in the vicinity of the target object to the extent that it can grasp the target object, and satisfies the following relationship with the logical variable δ.

δ=1⇔h(x)≥0

In this equation, the logical variable δ is set to 1, on the assumption that the robot hand grasps the target object if the robot hand exists in the vicinity of the target object to the extent that it can grasp the target object.

Further, “A” is a drift term representing the dynamics of the other working body hands 81 of the other working body 8 and can be defined by the following equation (2) or (3).

$$A = [ \begin{matrix}\frac{\partial {x}_{h 1}}{\partial t} & o \\ o & \frac{\partial {x}_{h 2}}{\partial t}\end{matrix} ] Δ t + I \qquad ( 2 )$$

$$A = [ \begin{matrix}Δ {x}_{h 1} & o \\ o & Δ {x}_{h 2}\end{matrix} ] + I \qquad ( 3 )$$

Here, “Δt” in the equation (2) indicates the time step interval, and “∂xₕ₁/∂t” and “∂xₕ₂/∂t” indicate the partial differentiations of the other worker hands 81 with respect to a time step. In this case, the other work abstract model determination unit 34 determines the other work abstract models Mo2 corresponding to “∂xₕ₁/∂t” and “∂xₕ₂/∂t” based on the operation sequence including the ongoing (current) operation and the predicted operation to be executed the other working body 8 and the other working body operation model information I7. Then, the whole abstract model generation unit 35 sets the equation (2) based on the other working body abstract models Mo2 determined by the other working body abstract model determination unit 34.

Further, as shown in the equation (3), the whole abstract model generation unit 35 may abstractly represent the dynamics of the other working body 8 using “Δxₕ₁” and “Δxₕ₂” which indicate the displacements of the positions of the other working body hands 81 per one time step, respectively. In this case, the other work abstract model determination unit 34 determines the other work abstract models Mo2 corresponding to “Δxₕ₁” and “Δxₕ₂” based on the operation sequence including the ongoing (current) operation and one or more predicted operations to be executed by the other working body 8 and the other working body operation model information 17. Then, the whole abstract model generation unit 35 sets the equation (3) based on the other working body abstract model Mo2 determined by the other working body abstract model determination unit 34.

Here, the expression (1) is a difference equation showing the relationship between the state of the objects at the time step k and the state of the objects at the time step k+1. Then, in the above expression (1), since the state of the grasp is represented by a logic variable that is a discrete value, and the movement of the target objects is represented by a continuous value, the expression (1) shows a hybrid system.

The expression (1) considers not the detailed dynamics of the entire robot 5 and the entire other working body 8 but only the dynamics of the robot hands of the robot 5 that actually grasp the target object and dynamics of the other working body hands 81. Thus, it is possible to suitably reduce the calculation amount of the optimization process by the control input generation unit 35.

Further, the abstract model information I5 includes information for deriving the difference equation according to the expression (1) from the object identification result R0 and the state recognition result R1 and the logical variable corresponding to the operation (the operation of grasping the target object i in the case of pick-and-place) causing the dynamics to switch. Thus, even when there is a variation in the position and the number of the target objects, the area (area G in FIG. 7) where the target objects are to be placed and the number of the robots 5 and the like, the abstract model generation unit 34 can determine the whole abstract model Σ in accordance with the environment of the target workspace 6 based on the abstract model information I5, the object identification result R0 and the state recognition result R1. Similarly, by using the other working body abstract model Mo2 determined by the other working body abstract model determination unit 34 based on the operation recognition result R2 and the predicted operation recognition result R3, the whole abstract model generation unit 3 can generate a whole abstract model Σ suitably considering the dynamics of the other working body 8.

It is noted that, in place of the model shown in the expression (1), the abstract model generation unit 35 may generate any other hybrid system model such as mixed logical dynamical (MLD) system, Petri nets, automaton, and their combination.

(6-6) Utility Function Design Unit and Control Input Generation Unit

The control input generation unit 37 determines the optimal control input to the robot 5 for each time step based on the time step logical formula Lts supplied from the time step logical formula generation unit 33, the whole abstract model Σ supplied from the whole abstract model generation unit 35, and the utility function supplied from the utility function design unit 36. In this case, the control input generator 37 solves the optimization problem of minimizing the utility function, which is designed by the utility function design unit 36, using the whole abstract model Σ and the time step logic formula Lts as constraint conditions.

When there are a plurality of other work bodies 8, the utility function design unit 36 designs the utility function in which the utility for the work of each of the other working bodies 8 is weighted based on the work efficiency of each of the other working bodies 8. When there are no plural other working bodies 8, the utility function to be used is predetermined for each type of the objective task, for example, and stored in the memory 12 or the storage device 4. In addition, the utility function to be used when there are a plurality of other work bodies 8 is a utility function including a parameter indicating the work efficiency of each of the other working bodies 8, and it is predetermined for each type of the objective task and for each number of other work bodies 8, for example, and is stored in the memory 12 or the storage device 4.

First, a specific example of the utility function when not considering the work efficiency of the other working body 8 will be described. When a pick-and-place is the objective task, the utility function design unit 36 defines the utility function so that the distance “dₖ” and the control input “uₖ” are minimized (i.e., the energy consumed by the robot 5 is minimized), wherein the distance dₖ is the distance between a target object to be carried and the goal point on which the target object is to be placed. The distance dₖ described above corresponds to the distance, at the time step k, between the target object (i=2) and the area G when the objective task is “the target object (i=2) is eventually present in the area G”.

In this case, the utility function design unit 36 determines, for example, the utility function to be the sum of the squared norm of the distance dₖ in all time steps and the squared norm of the control input uₖ. Then, the control input generation unit 37 solves the constrained mixed integer optimization problem shown in the following equation (4) using the whole abstract model Σ and the time step logical formula Lts (i.e., the logical OR of the candidates φᵢ) as constraint conditions.

$${min}_{u} ( {\sum }_{k = 0}^{T} ( {‖ {d}_{k} ‖}_{2}^{2} + {‖ {u}_{k} ‖}_{2}^{2} ) ) s . t . Σ ⋁ {ϕ}_{i} \qquad ( 4 )$$

Here, “T” is the number of time steps to be considered in the optimization and it may be a target time step number or may be a predetermined number smaller than the target time step number as described later. In some embodiments, the control input generation unit 37 approximates the logic variable by a continuous value (i.e., solve a continuous relaxation problem). Thereby, the control input generation unit 35 can suitably reduce the calculation amount. When STL is adopted instead of linear temporal logic (LTL), it can be described as a nonlinear optimization problem.

Next, a specific example of the utility function when considering the work efficiency of the other working bodies 8 will be described. In this case, the utility function design unit 36 provides, in the utility function, a parameter indicating the work efficiency for adjusting the work balance among the plural other working bodies 8. For example, when the pick-and-place by the worker A and the worker B, which are the other working bodies 8, is the objective task, the control input generation unit 37 solves the constrained mixed integer optimization problem shown in the following equation (5) using the whole abstract model Σ and the time step logic formula Lts as the constraint conditions.

$${min}_{u} ( {\sum }_{k = 0}^{T} ( \frac{b}{a + b} {\sum }_{i} {‖ {d}_{A i k} ‖}_{2}^{2} + \frac{a}{a + b} {\sum }_{j} {‖ {d}_{B j k} ‖}_{2}^{2} + {‖ {u}_{k} ‖}_{2}^{2} ) ) s . t . \sum ⋁ {ϕ}_{i} \qquad ( 5 )$$

In the equation (5), the utility function design unit 36 determines the utility function to be the weighted sum, at all time steps, of: squares of the norm of the distance vector “d_{Aik}” between the worker A and the target object i handled by the worker A; squares of the norm of the distance vector “d_{Bjk}” between the worker B and the target object j handled by the worker B; and squares of the norm of the control input “uₖ”. Here, “a” indicates the work efficiency of worker A, and “b” indicates the work efficiency of worker B. Here, “a” and “b” are scalar values and are normalized so as to satisfy “0<a, b<1”. Here, the larger the value “a” or “b” is, the higher the work efficiency of the corresponding worker becomes.

Then, according to the equation (5), the weights on the sum of squares of the norm of the distance vector “d_{Aik}” relating to the work by the worker A and the sum of squares of the norm of the distance vector “d_{Bjk}” relating to the work by the worker B decrease with increasing work efficiencies of the corresponding workers, respectively. Thus, the utility function design unit 36 can suitably design the utility function so that the control input of the robot 5 is determined so as to preferentially assist the worker with poor work efficiency (i.e., low work efficiency).

(6-7) Subtask Sequence Generation Unit

The subtask sequence generation unit 36 generates a subtask sequence based on the control input information Ic supplied from the control input generation unit 35 and the subtask information I4 stored in the application information storage unit 41. In this case, by referring to the subtask information I4, the subtask sequence generation unit 36 recognizes subtasks that the robot 5 can accept and converts the control input for each time step indicated by the control input information Ic into subtasks.

For example, in the subtask information I4, there are defined functions representing two subtasks, the movement (reaching) of the robot hand and the grasping by the robot hand, as subtasks that can be accepted by the robot 5 when the objective task is pick-and-place. In this case, the function “Move” representing the reaching is, for example, a function that uses the following arguments (parameters): the initial state of the robot 5 before the function is executed; the final state of the robot 5 after the function is executed; and the time to be required for executing the function. In addition, the function “Grasp” representing the grasping is, for example, a function that uses the following arguments: the state of the robot 5 before the function is executed; the state of the target object to be grasped before the function is executed; and the logical variable δ. Here, the function “Grasp” indicates performing a grasping operation when the logical variable δ is “1”, and indicates performing a releasing operation when the logic variable δ is “0”. In this case, the subtask sequence generation unit 36 determines the function “Move” based on the trajectory of the robot hand determined by the control input for each time step indicated by the control input information Ic, and determines the function “Grasp” based on the transition of the logical variable δ for each time step indicated by the control input information Ic.

Then, the subtask sequence generation unit 36 generates a subtask sequence configured by the function “Move” and the function “Grasp”, and supplies a control signal S3 indicating the subtask sequence to the robot 5. For example, if the objective task is “the target object (i=2) is finally present in the area G”, the subtask sequence generation unit 36 generates a subtask sequence of the function “Move”, the function “Grasp”, the function “Move”, and the function “Grasp” for the robotic hand closest to the target object 2. In this case, the robot hand closest to the target object (i=2) moves to the position of the target object 2 by the function “Move”, grasps the target object (i=2) by the function “Grasp”, moves to the area G by the function “Move”, and places the target object (i=2) in the area G by the function “Grasp”.

(7) Process Flow

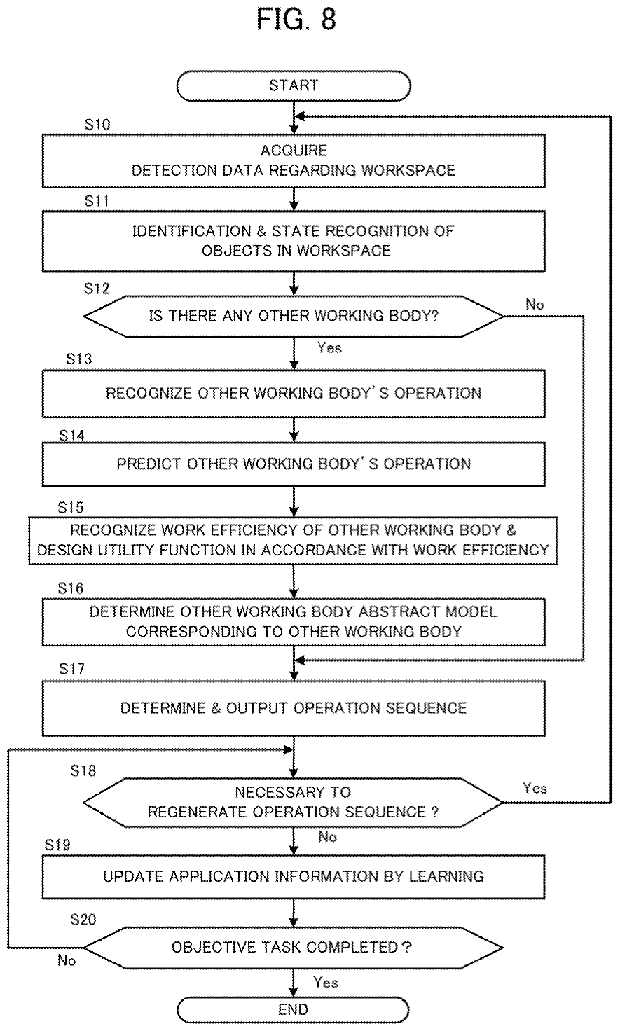

FIG. 8 is an example of a flowchart showing an outline of the robot control process performed by the control device 1 in the first example embodiment.

First, the control device 1 acquires the detection signal S4 supplied from the detection device 7 (step S10). Then, the recognition unit 15 of the control device 1 performs the identification and state recognition of objects present in the workspace 6 based on the detection signal S4 and the object model information I6 (step S11). Thereby, the recognition unit 15 generates the object identification result R0 and the state recognition result R1.

Next, the control device 1 determines whether or not there is any other working body 8 based on the object identification result R0 (step S12). When it is determined that there is any other working body 8 (step S12; Yes), the control device 1 executes the process at step S13 to S16. On the other hand, when it is determined that there is no other working body 8 (step S12; No), the control device 1 proceeds to the process at step S17.

After the determination that there is any other working body 8 (step S12; Yes), the recognition unit 15 recognizes the operation executed by the other working body 8 present in the workspace 6 based on the operation recognition information I8 (step S13). Thereby, the recognition unit 15 generates an operation recognition result R2. Furthermore, the recognition unit 15 predicts, based on the operation prediction information I9 and the operation recognition result R2, the operation executed by the other working body 8 (step S14). Thereby, the recognition unit 15 generates a predicted operation recognition result R3. Furthermore, the recognition unit 15 recognizes the work efficiency of the other working body 8 based on the object identification result R0 and the work efficiency information I10, and the operation sequence generation unit 17 designs the utility function according to the work efficiency of the other working body 8 (step S15). The recognition unit 15 and the operation sequence generation unit 17 may execute the process at step S15 only when a plurality of other work bodies 8 are detected. Furthermore, the operation sequence generation unit 17 determines the other working body abstract model Mo2 representing the abstract dynamics of the other working body 8 existing in the workspace 6 on the basis of the operation recognition result R2, the predicted operation recognition result R3, and the other working body operation model information I7 (step S16).

Then, after the process at step S17 or after the determination that there is no other working body 8 (step S12; No), the operation sequence generation unit 17 determines the subtask sequence that is an operation sequence of the robot 5 and outputs a control signal S3 indicating the subtask sequence to the robot 5 (step S17). At this time, the operation sequence generation unit 17 generates the subtask sequence based on the whole abstract model Σ in which the other working body abstract model Mo2 determined at step S25 is reflected. Thereby, the operation sequence generation unit 17 can suitably generate a subtask sequence that is an operation sequence of the robot 5 cooperating with the other working body 8. Thereafter, the robot 5 starts the operation for completing the objective task based on the control signal S3.

Next, the control device 1 determines whether or not to regenerate the subtask sequence, which is an operation sequence of the robot 5 (step S18). In this case, for example, when a predetermined time has elapsed since the immediately preceding generation of the subtask sequence or when a predetermined event, such as an event that the robot 5 cannot execute the instructed subtask, is detected, the control device 1 determines that the subtask sequence needs to be regenerated. When the regeneration of the subtask sequence is necessary (step S18: Yes), the control device 1 gets back to the process at step S10 and starts the process necessary for generating the subtask sequence.

On the other hand, when it is determined that regeneration of the subtask sequence is unnecessary (step S18; No), the learning unit 16 updates the application information by learning (step S19). Specifically, the learning unit 16 updates, based on the recognition result R by the recognition unit 15, the other working body operation model information I7, the operation prediction information I9, and the work efficiency information I10 stored in the application information storage unit 41. It is noted that the learning unit 16 may execute the process at step S19 not only during the execution of the subtask sequence by the robot 5 but also before or after the execution of the subtask sequence by the robot 5.

Then, the control device 1 determines whether or not the objective task is completed (step S20). In this case, the control device 1 determines whether or not the objective task is completed based on, for example, the recognition result R generated from the detection signal S4 or a notification signal supplied from the robot 5 for notifying the completion of the objective task. Then, when it is determined that the objective task has been completed (step S20; Yes), the control device 1 end the process of the flowchart. On the other hand, when it is determined that the objective task has not been completed (step S20; No), the control device 1 gets back to the process at step S18, and continuously determines whether or not to regenerate the subtask sequence.

(8) Application Examples

Next, application examples (the first application example to the third application example) according to the first example embodiment will be described.

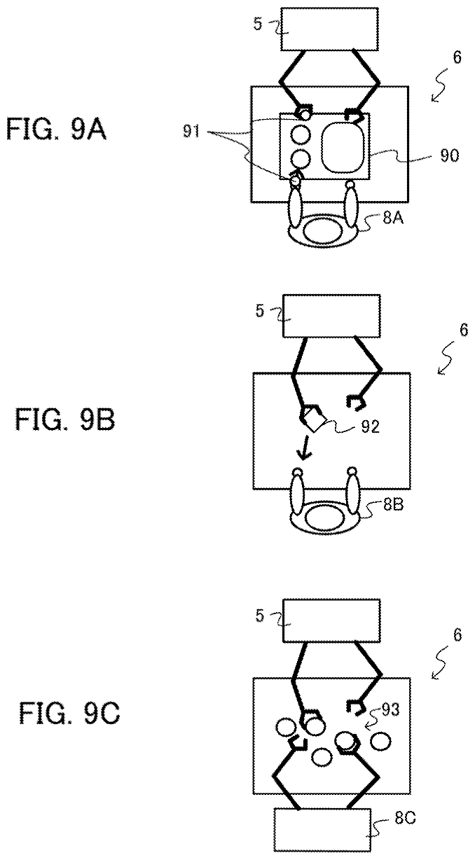

In the first application example, in a food factory, an assembly factory, or a workspace of a distribution, the robot 5 performs cooperative operation in accordance with the worker 8A that is the other working body 8 to work in the same workspace 6. FIG. 9A is an example of a bird's-eye view of the workspace 6 in the first application example. In FIG. 9A, the work of packing a plurality of ingredients 91 to the lunch box 90 at predetermined positions, respectively, is given as an objective task, and the information indicative of the prior knowledge necessary for executing the objective task is stored in advance in the application information storage unit 41. This prior knowledge includes information (information indicative of a so-called completion drawing) indicating the respective ingredients 91 to be packed in the lunch box 90, the arrangement of the ingredients 91, and rules in performing the objective task.

In this case, based on the detection signal S4, the recognition unit 15 of the control device 1 performs identification and state recognition of each object such as lunch box 90 in the workspace 6. Further, the recognition unit 15 recognizes that the worker 8A performs the operation of packing an ingredient 91 while predicting that the operation to take a next ingredient 91 after the packing operation is performed. Then, the other working body abstract model determination unit 34 of the operation sequence generation unit 17 determines the other working body abstract model Mo2 corresponding to the worker 8A on the basis of the operation recognition result R2 and the predicted operation recognition result R3 recognized by the recognition unit 15, and the other working body operation model information I7. Thereafter, the whole abstract model generation unit 35 of the operation sequence generation unit 17 generates the whole abstract model Σ, which corresponds to the entire workspace 6, based on: the state recognition result R1 indicating the position and posture of the respective ingredients 91 and the lunch box 90; the abstract dynamics of the robot 5; and the other working body abstract model Mo2. Then, the subtask sequence generation unit 38 of the operation sequence generation unit 17 generates a subtask sequence that is an operation sequence to be executed by the robot 5 based on the control input information Ic generated by the control input generation unit 37 which uses the generated whole abstract model Σ. In this case, the operation sequence generation unit 17 generates a subtask sequence for achieving the objective task so as not to interfere with the operation of packing the ingredient 91 by the worker 8A.

In the second application, in various factories, medical sites, or fields of retail businesses, the robot 5 delivers/receives an object to or from the worker 8B that is the other working body 8 to work in the same workspace 6. Here, examples of the items to be delivered or received between the worker 8B and the robot 5 includes tools, medical equipment, change, and shopping bags. FIG. 9B is an example of a bird's-eye view of the workspace 6 in the second application example. In FIG. 9B, the assembly of a product is given as an objective task, and the prior knowledge regarding parts and tools necessary for assembling the product is stored in the application information storage unit 41. This prior knowledge includes prior knowledge that the tool 92 is necessary to turn a screw.

In this case, after performing the identification and state recognition of the objects present in the workspace 6, the recognition unit 15 recognizes that the worker 8B is performing the operation of “removing a screw” while predicting that the worker 8B will perform the operation of “turning a screw” after the recognized operation. On the basis of the operation recognition result R2 and the predicted operation recognition result R3 by the recognition unit 15, the other working body abstraction model determination unit 34 selects the other working body operation models Mo1 corresponding to the respective operations of “removing a screw” and “turning a screw” by the worker 8B with reference to the other working body operation model information 17. Thereafter, the whole abstract model generation unit 35 generates the whole abstract model Σ targeting the entire workspace 6 by using the other working body abstract model Mo2 in which the selected other working body operation models Mo1 are combined. Then, based on the control input information Ic generated by the control input generation unit 37 from the generated whole abstract model Σ, the subtask sequence generation unit 38 generates a subtask sequence that is an operation sequence to be executed by the robot 5.

The subtask sequence generated by the control device 1 in the second application includes a subtask for picking up a tool 92 needed to turn the screw and a subtask for delivering the tool 92 picked up to the worker 8B. By sending a control signal S3 indicative of the subtask sequence to the robot 5, the control device 1 can suitably support the worker 8B by the robot 5. Thus, the robot 5 may perform a subtask sequence that includes delivery and/or receipt of objects to and from the other working body 8.

In the third application, in various factories such as food factories and assembly factories, the robot 5 works with another robot 8C which is the other working body 8 to work in the workspace 6 to be the same line or cell. FIG. 9C is an example of a bird's-eye view of the workspace 6 in the third application example. Here, a pick-and-place of a plurality of target objects 93 is given as an objective task, and prior knowledge necessary for executing the objective task is stored in the application information storage unit 41.

In this case, the learning unit 16 learns the operation sequence periodically executed by the other robot 8C and the parameters of the operation sequence based on the time series data of the recognition result R supplied from the recognition unit 15 before or after the generation of the subtask sequence by the control device 1. Then, the learning unit 16 updates the other working body operation model information I7 and the operation prediction information I9 based on the learned operation sequence and parameters of the operation sequence. Then, after updating the other working body operation model information I7 and the operation prediction information I9, the control device 1 generates a subtask sequence to be executed by the robot 5 using the other working body operation model information I7 and the operation prediction information I9 that have been updated, and transmits a control signal S3 indicative of the subtask sequence to the robot 5.

In this way, in the third application, the control device 1 learns the operation sequence executed by the other robot 8C, thereby allowing the robot 5 to execute a subtask sequence accurately considering the movement of the other robot 8C.

(9) Modification

The process of predicting the operation to be executed by the other working body 8 by the operation prediction unit 24, the recognition process of the work efficiency by the work efficiency recognition unit 25, the design process of the utility function by the utility function design unit 36 based on the work efficiency, and the learning process by the learning unit 16 are not essential processes. Therefore, the control device 1 may not execute at least one of these processes.

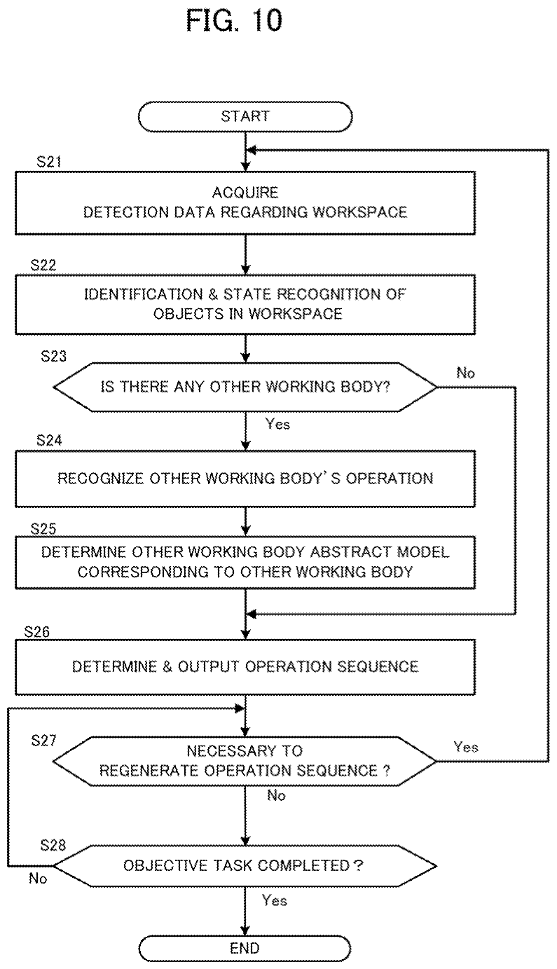

FIG. 10 is an example of a flowchart showing an outline of the robot control process of the control device 1 in the modification. The flowchart shown in FIG. 10 shows the procedure of the robot control process when all of the above-described process of predicting the operation, design process of the utility function, and learning process are not executed. Hereinafter, the explanation of step S21 to step S24 shown in FIG. 10 corresponding to the same process as step S10 to step S13 shown in FIG. 8 will be omitted.

After the recognition unit 15 recognizes the operation executed by the other working body 8 at step S24, the operation sequence generation unit 17 determines the other working body abstract model Mo2 based on the operation recognition result R2 and the other working body operation model information I7 (step S25). In this case, the other working body abstract model determination unit 34 of the operation sequence generating unit 17 selects the other working body operation models Mo1 corresponding to the operations indicated by the operation recognition result R2 from the other working body operation model information I7, and determines the other working body abstract model Mo2 to be the other working body operation models Mo1.

Then, after the process at step S25 or after the determination that there is no other working body 8 (step S23; No), the operation sequence generation unit 17 determines the subtask sequence that is the operation sequence of the robot 5 and outputs a control signal S3 indicating the subtask sequence to the robot 5 (step S26). At this time, the operation sequence generation unit 17 generates the whole abstract model Σ based on the other working body abstract models Mo2 determined at step S25 to generate a subtask sequence. Thereby, the operation sequence generation unit 17 can suitably generate a subtask sequence that is an operation sequence of the robot 5 cooperating with the other working body 8.

Next, the control device 1 determines whether or not to regenerate the subtask sequence that is the operation sequence of the robot 5 (step S27). When the subtask sequence needs to be regenerated (step S27; Yes), the control device 1 gets back to the process at step S21 and starts the process necessary for generating the subtask sequence. On the other hand, when it is determined that regeneration of the subtask sequence is unnecessary (step S27; No), the control device 1 determines whether or not the objective task has been completed (step S28). When it is determined that the objective task has been completed (step S28; Yes), the control device 1 terminates the processing of the flowchart. On the other hand, when it is determined that the objective task has not been completed (step S28; No), the control device 1 gets back to the process at step S27 and continuously determines whether or not to regenerate the subtask sequence.

Thus, according to this modification, the control device 1 can control the robot 5 so that the robot 5 operates based on the subtask sequence that is the operation sequence of the robot 5 cooperating with the other working body 8.

### Second Example Embodiment

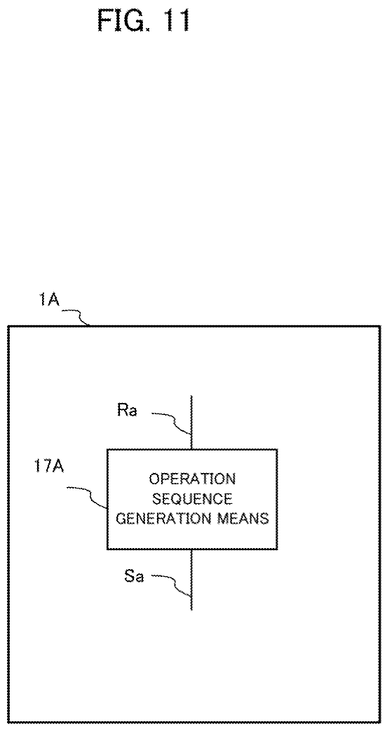

FIG. 11 is a schematic configuration diagram of a control device 1A in the second example embodiment. As shown in FIG. 11, the control device 1A mainly includes an operation sequence generation means 17A.

The operation sequence generation means 17A is configured to generate, based on recognition results “Ra” relating to types and states of objects present in a workspace where a robot which performs a task and another working body perform cooperative work, an operation sequence “Sa” to be executed by the robot.

Here, the robot may be configured separately from the control device 1A, or may incorporate the control device 1A. Examples of the operation sequence generation means 17A include the operation sequence generation unit 17 configured to generate a subtask sequence based on the recognition results R outputted from the recognition unit 15 in the first example embodiment. In this case, the recognition unit 15 may be a part of the control device 1A or may be configured separately from the control device 1A. Further, the recognition unit 15 may only include the object identification unit 21 and the state recognition unit 22. Further, the operation sequence generation means 17A does not need to consider the dynamics of the other working body in generating the operation sequence. In this case, the operation sequence generation means 17A may consider the other working body as an obstacle and generate the operation sequence such that the robot does not interfere with the other working body based on the recognition result R.

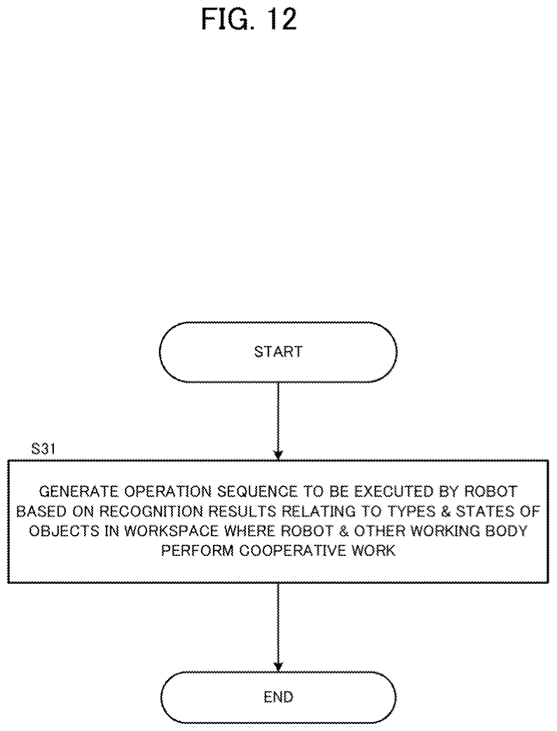

FIG. 12 is an example of a flowchart executed by the control device 1A in the second example embodiment. The operation sequence generation means 17A is configured to generate, based on recognition results Ra relating to types and states of objects present in a workspace where a robot which performs a task and another working body perform cooperative work, an operation sequence Sa to be executed by the robot (step S31).

According to the configuration of the second example embodiment, the control device 1A can suitably generate an operation sequence to be executed by the robot when the robot and the other working body performs cooperative work.

In the example embodiments described above, the program is stored by any type of a non-transitory computer-readable medium (non-transitory computer readable medium) and can be supplied to a control unit or the like that is a computer. The non-transitory computer-readable medium include any type of a tangible storage medium. Examples of the non-transitory computer readable medium include a magnetic storage medium (e.g., a flexible disk, a magnetic tape, a hard disk drive), a magnetic-optical storage medium (e.g., a magnetic optical disk), CD-ROM (Read Only Memory), CD-R, CD-R/W, a solid-state memory (e.g., a mask ROM, a PROM (Programmable ROM), an EPROM (Erasable PROM), a flash ROM, a RAM (Random Access Memory)). The program may also be provided to the computer by any type of a transitory computer readable medium. Examples of the transitory computer readable medium include an electrical signal, an optical signal, and an electromagnetic wave. The transitory computer readable medium can provide the program to the computer through a wired channel such as wires and optical fibers or a wireless channel.

The whole or a part of the example embodiments described above can be described as, but not limited to, the following Supplementary Notes.

[Supplementary Note 1]

A control device comprising:
an operation sequence generation means configured to generate,
   based on recognition results relating to types and states of objects present in a workspace where a robot which performs a task and another working body perform cooperative work,
   an operation sequence to be executed by the robot.

[Supplementary Note 2]
The control device according to Supplementary Note 1,
wherein the operation sequence generation means is configured to:
   determine, based on the recognition results relating to an operation by the other working body, an other working body abstract model in which dynamics of the other working body is abstracted; and
   generate the operation sequence based on the other working body abstract model and the recognition results relating to the types and the states of the objects.

[Supplementary Note 3]
The control device according to Supplementary Note 2,
wherein the operation sequence generation means is configured to determine the other working body abstract model based on other working body operation model information indicative of a model in which the dynamics of the other working body is abstracted for each operation.

[Supplementary Note 4]
The control device according to Supplementary Note 2 or 3, further comprising
a learning means configured to learn parameters of the other working body abstract model based on the recognition results relating to the operation by the other working body.

[Supplementary Note 5]
The control device according to any one of Supplementary Notes 2 to 4,
wherein the recognition results relating to the operation by the other working body includes recognition results relating to an ongoing operation and a predicted operation to be executed by the other working body, and
wherein the operation sequence generation means is configured to generate the operation sequence based on the recognition results relating to the ongoing operation and the predicted operation to be executed by the other working body.

[Supplementary Note 6]
The control device according to any one of Supplementary Notes 1 to 5,
wherein the operation sequence generation means is configured to generate the operation sequence based on a work efficiency of each of other working bodies that are plural of the other working body.

[Supplementary Note 7]
The control device according to Supplementary Note 6,
wherein the operation sequence generation means is configured to
   design a utility function in which a utility for each work of the other working bodies is weighted based on the work efficiency of each of the other work bodies and
   optimize the utility function to generate the operation sequence.

[Supplementary Note 8]
The control device according to any one of Supplementary Notes 1 to 7, further comprising
a recognition means configured to recognize the types and the states of the objects based on a detection signal outputted by a detection device whose detection range includes the workspace,
wherein the operation sequence generation means is configured to generate the operation sequence based on the recognition results by the recognition means.

[Supplementary Note 9]
The control device according to any one of Supplementary Notes 1 to 8,
wherein the operation sequence generation means comprises:
   a logical formula conversion means configured to convert an objective task, which is a task to be performed by the robot, into a logical formula based on a temporal logic;
   a time step logical formula generation means configured to generate, from the logical formula, a time step logical formula that is a logical formula representing states at each time step for completing the objective task; and
   a subtask sequence generation means configured to generate, based on the time step logical formula, the operation sequence that is a sequence of subtasks to be executed by the robot.

[Supplementary Note 10]
The control device according to Supplementary Note 9,
wherein the operation sequence generation means further comprises:
   an abstract model generation means configured to generate an abstract model in which dynamics in the workspace is abstracted;
   a utility function design means configured to design a utility function for the objective task; and
   a control input generation means configured to generate a control input for each time step for controlling the robot based on the abstract model, the time step logic formula, and the utility function,
wherein the subtask sequence generation means is configured to generate the sequence of the subtasks based on the control input.

[Supplementary Note 11]
The control device according to Supplementary Note 9 or 10,
wherein the operation sequence generation means further comprises
   an abstract state setting means configured to define, based on the recognition results, an abstract state, which is an abstract state of the objects present in the workspace, as propositions to be used in the logical formula.

[Supplementary Note 12]
A control method executed by a computer, the control method comprising generating,
   based on recognition results relating to types and states of objects present in a workspace where a robot which performs a task and another working body perform cooperative work,
   an operation sequence to be executed by the robot.

[Supplementary Note 13]
A storage medium storing a program executed by a computer, the program causing the computer to function as:
an operation sequence generation means configured to generate,
   based on recognition results relating to types and states of objects present in a workspace where a robot which performs a task and another working body perform cooperative work,
   an operation sequence to be executed by the robot.

While the invention has been particularly shown and described with reference to example embodiments thereof, the invention is not limited to these example embodiments. It will be understood by those of ordinary skilled in the art that various changes in form and details may be made therein without departing from the spirit and scope of the present invention as defined by the claims. In other words, it is needless to say that the present invention includes various modifications that could be made by a person skilled in the art according to the entire disclosure including the scope of the claims, and the technical philosophy. All Patent and Non-Patent Literatures mentioned in this specification are incorporated by reference in its entirety.

### DESCRIPTION OF REFERENCE NUMERALS

1, 1A Control device
2 Input device
3 Display device
4 Storage device
5 Robot
6 Workspace
7 Detection device
8, 8A to 8C Other working body
41 Application information storage unit
100 Control system

What is claimed is:

1. A control device comprising:
at least one memory configured to store instructions; and
at least one processor configured to execute the instructions to generate,
based on recognition results relating to types and states of objects present in a workspace where a robot which performs a task and another working body perform cooperative work,
an operation sequence to be executed by the robot.

2. The control device according to claim 1,
wherein the at least one processor is configured to execute the instructions to:
determine, based on the recognition results relating to an operation by the other working body, an other working body abstract model in which dynamics of the other working body is abstracted; and
generate the operation sequence based on the other working body abstract model and the recognition results relating to the types and the states of the objects.

3. The control device according to claim 2,
wherein the at least one processor is configured to execute the instructions to determine the other working body abstract model based on other working body operation model information indicative of a model in which the dynamics of the other working body is abstracted for each operation.

4. The control device according to claim 2,
wherein the at least one processor is configured to further execute the instructions to learn parameters of the other working body abstract model based on the recognition results relating to the operation by the other working body.

5. The control device according to claim 2,
wherein the recognition results relating to the operation by the other working body includes recognition results relating to an ongoing operation and a predicted operation to be executed by the other working body, and
wherein the at least one processor is configured to execute the instructions to generate the operation sequence based on the recognition results relating to the ongoing operation and the predicted operation to be executed by the other working body.

6. The control device according to claim 1,
wherein the at least one processor is configured to execute the instructions to generate the operation sequence based on a work efficiency of each of other working bodies that are plural of the other working body.

7. The control device according to claim 6,
wherein the at least one processor is configured to execute the instructions to
design a utility function in which a utility for each work of the other working bodies is weighted based on the work efficiency of each of the other work bodies and
optimize the utility function to generate the operation sequence.

8. The control device according to claim 1,
wherein the at least one processor is configured to further execute the instructions to recognize the types and the states of the objects based on a detection signal outputted by a detection device whose detection range includes the workspace,
wherein the at least one processor is configured to execute the instructions to generate the operation sequence based on the recognition result.

9. The control device according to claim 1,
wherein the at least one processor is configured to execute the instructions to
convert an objective task, which is a task to be performed by the robot, into a logical formula based on a temporal logic;
generate, from the logical formula, a time step logical formula that is a logical formula representing states at each time step for completing the objective task; and
generate, based on the time step logical formula, the operation sequence that is a sequence of subtasks to be executed by the robot.

10. The control device according to claim 9,
wherein the at least one processor is configured to execute the instructions to:
generate an abstract model in which dynamics in the workspace is abstracted;
design a utility function for the objective task; and
generate a control input for each time step for controlling the robot based on the abstract model, the time step logic formula, and the utility function,
wherein the at least one processor is configured to execute the instructions to generate the sequence of the subtasks based on the control input.

11. The control device according to claim 9,
wherein the at least one processor is configured to execute the instructions
to define, based on the recognition results, an abstract state, which is an abstract state of the objects present in the workspace, as propositions to be used in the logical formula.

12. A control method executed by a computer, the control method comprising
generating,
based on recognition results relating to types and states of objects present in a workspace where a robot which performs a task and another working body perform cooperative work,
an operation sequence to be executed by the robot.

13. A non-transitory computer readable storage medium storing a program executed by a computer, the program causing the computer to:
generate,
based on recognition results relating to types and states of objects present in a workspace where a robot which performs a task and another working body perform cooperative work,
an operation sequence to be executed by the robot.
